(19) United States
(12) Patent Application Publication
(10) Pub. No.: US 2021/0316240 A1
(43) Pub. Date: Oct. 14, 2021

(54) LASER-SINTERED FILTER, METHOD FOR PRODUCING THE FILTER, AND METHOD FOR ENSURING FLUID FLOW

(71) Applicant: Karl Leibinger Medizintechnik GmbH & Co. KG, Mühlheim (DE)

(72) Inventors: Adem AKSU, Villingen--Schwenningen (DE); Frank REINAUER, Emmingen-Liptingen (DE); Tobias WOLFRAM, Dreieich (DE)

(21) Appl. No.: 17/272,780

(22) PCT Filed: Sep. 4, 2019
(86) PCT No.: PCT/EP2019/073529

§ 371 Date: Mar. 2, 2021

(30) Foreign Application Priority Data
Sep. 4, 2018 (DE) 10 2018 121 552.5

(51) Int. Cl. B01D 39/16; B01D 67/00; B01D 71/26

(52) U.S. Cl. CPC B01D 39/1661; B01D 67/0004; B01D 2239/1208; B01D 2239/0421; B01D 2239/10; B01D 71/26

(57) ABSTRACT

The invention relates to a filter (1) for cleaning fluids, having a main part (2) consisting of polyethylene particles (3) that have been bonded to each other by means of a generative manufacturing process such as to obtain a predefined macro- and microstructure, the main part (2) having regions in which the porosity is deliberately adjusted to varying values. The invention also relates to a method for producing a filter (1), the filter being generatively manufactured by selective laser sintering of polyethylene particles (3). The invention finally relates to a method for ensuring fluid flow.

The invention relates to a filter for cleaning fluids, i.e. liquids and/or gases. The invention also relates to a method for manufacturing such a filter. The invention also relates to a method for transporting fluids, for example by means of such a filter.

The prior art already shows filters for filtering liquid media. For example, DE 10 2007 049 658 A1 discloses a filter for filtering liquid medium with a filter chamber into which at least one filter element that can be backflushed can be inserted in the form of a hollow cylindrical filter body, the circumferential wall of which can be flowed through by the medium to be filtered, forming an inflow side and an outflow side, and the filter chamber has at least one filtrate outlet, a non-filtrate inlet and a backflush outlet, wherein filtrate can be injected for backflushing through a filtrate outlet for flowing to the outflow side, wherein the filter body of the filter element is a stable, porous molded body made of a polyethylene granulate fused by sintering, and for two-stage backflushing the filter chamber additionally has a compressed air inlet for applying compressed air to the outflow side of the filter element.

Such filters are often constructed from polyethylene (PE), since polyethylene, in particular ultra-high-molecular-weight polyethylene (UHMWPE) or high-density polyethylene (HDPE), but also polypropylene (PP), have particularly good compatibility and chemical resistance. Filter technologies are used in a wide variety of applications, for example in medical technology, automotive engineering, household technology, industrial technology or in the stationery industry. Maximum requirements are placed on microscopically small areas. The smallest particles, such as blood, water, air or oil, can be filtered out of contaminated substances by the filters.

Up to now, such filters have often been manufactured by sintering, in particular by compression molding. In this process, the PE particles are pressed in powder form or as powder grains in a mold, i.e. they are solidified under pressure, and then sintered. However, a disadvantage of this is that the geometry of the filter is thereby shape-bound and is therefore limited. For example, it is not possible to manufacture sintered filters with recesses/undercuts or a complicated geometry with a proportional amount of effort. Also, in order to manufacture the sintered filters, a corresponding mold has to be made first, which has a negative impact on manufacturing flexibility, costs as well as manufacturing time. In addition, in a mold-based manufacturing process such as sintering, a demoldability of the workpiece, i.e. the filter, has to be taken into account, which leads to further limitations in the geometric design of the filter.

Thus, it is the object of the invention to avoid or at least reduce the disadvantages of the prior art. In particular, a filter made of polyethylene particles as well as a manufacturing method are to be provided which eliminate the above-mentioned disadvantages. In particular, a filter that is easy to manufacture, can be manufactured at low costs and can be manufactured with complex geometries is to be developed.

The object of the invention is solved by a filter for cleaning fluids, i.e. liquids and gases, having a main body made of polyethylene particles which are bonded to each other by means of a generative manufacturing process in such a way that a predefined macrostructure and microstructure is produced. In this context, a microstructure or microporosity is understood to be a structure of the main body that is produced as a result of the process of manufacturing the filter from a mostly powder-like material. This means, that the microporosity is determined by process parameters such as particle size. A macrostructure or macroporosity is understood to be a structure of the main body that arises as a result of the design. This means, in particular, that the macroporosity can be specifically adjusted, for example, to determine the outer and/or inner geometry, the appearance, the surface properties and/or the microsection of the main body.

According to the invention, the main body can have areas in which the porosity is selectively set differently. In other words, the porosity of the main body is not the same in every region of the main body, but varies. This means that the main body has a different porosity in first regions than in second regions of the main body that are arranged at a distance from the first regions. The first regions and the second regions may even be adjacent to each other. Preferably, the main body of the filter has a total porosity that is between 1% and 60%. This ensures that the filter properties are good while allowing sufficient fluid to flow through the filter.

This has the advantage that, in a filter according to the invention, the microporosity and the macroporosity can be combined or adjusted in almost any way. In addition, the filter can be manufactured without the need for (tool) molds, which makes the necessity, for example, to consider the demoldability of the filter in the constructive design obsolete. Thus, any constructive design of the filter can be selected, for example with recesses/undercuts, with any porosities that vary section by section, in particular layer by layer. Also, the filter can be manufactured directly from a computer model, such as a CAD design, without having to first create a mold for the associated geometry, which has a favorable effect on the manufacturing costs and manufacturing time for the filter.

Advantageous embodiments are claimed in the dependent claims and are explained in more detail hereinafter.

In particular, the filter may have greater porosity on the surface than on the interior. Due to the higher permeability at the surface, the fluid to be filtered can easily enter the entire main body. In contrast to a conventional filter, where the surface is nearly flat due to the mechanical deformation of the outer particles, a high surface roughness and thus a large surface-to-volume ratio can thus be provided. Targeted adjustable porosity is thus also understood to mean that the surface (and the interior) has a defined structure.

It is also advantageous if the filter has a coarse-grained surface structure. For example, the surface structure is formed in a scatter-like manner. In particular, the particles are undeformed at the surface, i.e. not mechanically deformed. Accordingly, the particles are rounded out at the surface. This provides a particularly uneven surface which has favorable filtering properties.

In addition, it is expedient if the generative manufacturing method includes the use of a laser. This allows the polyethylene particles to be selectively melted, in particular locally, and to be fused together to form a body with a new geometry.

It is also advantageous if the filter is designed as a laser-sintered component. In this way, the occurrence of material distortion can be prevented to the greatest possible extent. Furthermore, in the field of selective laser sintering, a great deal of expertise is already known from other technical fields, which can be adapted for the technical field of filter technology.

For example, the use of polyethylene is known in particular from the field of medical technology due to its inert properties and good compatibility. To this end, DE 10 2016 110 500 A1 discloses a method for manufacturing an implant, wherein particles of the group consisting of ultra-high-molecular-weight polyethylene (UHMWPE) and/or high-density polyethylene (HDPE) and/or polypropylene (PP) are fused or sintered together in layers by means of a selective laser sintering process (SLS process).

It is also advantageous if the particles of the main body are distributed in layers, wherein the particles of one layer are fused or sintered together by means of a laser and the particles from different layers are fused or sintered together by means of a laser. This allows different properties to be set in the main body of the filter from layer to layer, in particular with regard to the grain size and/or grain shape used or the porosity set. The filter can thus also be designed to be partly solid and partly porous, so that the strength and/or filter properties can be adapted to the particular requirement.

In addition, it is expedient if each of the layers is a porous layer and/or is composed almost entirely, i.e. more than 98%, of PE particles, in particular UHMWPE, HDPE, alternatively also PP particles.

Preferably, a layer thickness of the main body is between 70 to 300 μm, preferably about 120 μm. Thus, the structure of the main body can be varied in sufficiently small ranges to be able to adjust almost any macroporosity of the main body.

In a preferred embodiment, the particles in powder form can have a diameter of between 20 and 400 μm. This means, therefore, that the particles present as powder grains have, for example, a diameter of between 40 and 200 μm, preferably about 130 to 155 μm. Particularly fine-grained polyethylene particles are thus used, which are fused together, for example in a preceding process, to form coarser-grained particles, i.e. particles with a larger diameter, depending on the particle size required for a desired (micro)porosity for the particular application. Preferably, the pore size of the filter is between 1 and 3500 μm.

It is particularly preferred if a particle size of the particles is varied within a main body of the filter. Preferably, therefore, particles of different sizes are used. In this way, a process-related microporosity can be adjusted.

In addition, it is advantageous if the particles are fused or sintered together to form a solid body or a (porous) body comprising porosities. Thus, an interconnecting pore structure of the filter is formed. Advantageously, a complex geometry, for example with varying wall thickness and/or with undercuts, can thus be formed from the PE particles. As a result of the primary, mold-free production, there are hardly any restrictions on the geometry of the filter.

It is also preferred if the filter has recesses/undercuts and/or cavities. Depending on the intended use, this also allows previously unmanufacturable geometries to be formed for the filter. This also allows, for example, fastening devices to be integrally formed on the filter, so that the filter can be particularly easily attached in its final position in a filter system.

In order to be able to remove any granules, particles and/or powder residues from the filter, it is advantageous if a surface treatment is carried out in the manner of a plasma treatment, a snow jet, a pressurized bombardment with frozen CO2 flakes or an ultrasonic bath. A surface of the sintered filter or sintered filter system can also be slightly roughened so that, for example, adhesion properties are improved.

Alternatively, the filter can also be subjected to surface cleaning by means of hot air, explosive deburring and/or chemical treatment, so that advantageously any residual particles on the surface that could, for example, block pores of the filter are removed.

In addition, it is preferred that the filter is subjected to a heat treatment in order to increase its strength. Preferably, the filter contains a strength increase between the interconnecting pore strands. Thus, advantageously, the strength and/or stiffness of the filter can be adjusted. For example, it is possible to achieve a high load-bearing capacity despite the porous structure of the filter, so that the filter can be used in many fields of application.

It is particularly preferred if the heat treatment is carried out after the surface treatment. This ensures that the pores of the filter remain open or unclosed, which has a favorable effect on the stability of the filter.

It is particularly advantageous if the polyethylene particles and/or the main body of the filter are provided with a metal doping or a ceramic doping. In a preferred further development, the main body of the filter is provided with particle doping so that it has antimicrobial properties. That means that particles are added to the PE particles in small amounts, i.e. <1%, during the manufacturing process in order to influence the properties of the filter so that, for example, germ growth, bacteria and viruses can be prevented. However, other particle dopants can also be provided, such as magnesium, potassium, sodium or salts.

In a preferred embodiment, the filter is antistatic. This advantageously separates explosive dusts, so that the risk of explosion is reduced.

It is also useful if the particles of the main body are round, potato-shaped, angular, polyhedron-shaped, sheared with a tear-off edge, shredded, chip-like and/or oval. Thus, they can be formed with almost any shape, since the grain shape is significantly influenced in the manufacturing process and the desired structure is achieved. Preferably, particularly fine grain sizes up to a maximum of 130 μm are used.

Furthermore, it is advantageous if the surface of the main body is plasma-treated, in particular low-pressure plasma-treated. This has the advantage that a hydrophilicity and/or hydrophobicity of the surface of the filter can be adjusted. In the case of a hydrophilic design, for example, the filtration properties of the filter are improved. It is particularly preferred if one side of the filter is hydrophilic and/or another side, in particular an opposite side, is hydrophobic.

The object of the invention is also solved by a method for producing a filter, wherein the filter is produced generatively by selective laser sintering of polyethylene particles. In this context, advantageous embodiments described above in connection with the filter apply equivalently to the process according to the invention.

Thus, it is preferred if the filter is produced by laser sintering and is subsequently subjected to a heat treatment and/or a surface treatment and/or a low-pressure plasma treatment and/or surface cleaning.

According to the invention, it is also proposed to implement the following steps for manufacturing the filter: providing (a certain amount, for example measured by volume and/or weight) of a preferably free-flowing PE powder; heating and compressing the PE powder while forming at least one intermediate piece; mechanically crushing the at least one intermediate piece into granules, for example having a predetermined grain size and/or grain shape; and joining the granules to form the main body of the filter.

By means of the process steps mentioned, the PE granules and thus the main body of the filter can be provided predominantly or completely by mechanical processing steps. By pressing the PE powder into intermediate pieces and subsequent mechanical comminution, defined and uniform particles can be used as granules, so that a manufacturing process that is as reproducible as possible is provided. This means, for example, that the microporosity of the filter can be specifically adjusted.

The invention also relates to a method for liquid transport, in which a component laser-sintered from polyethylene particles is brought into contact with a liquid at a first region of the component in order to transfer the liquid to a second region of the component. Due to the specific adjustability of the microstructure and/or macrostructure of the laser-sintered component, the capillary effect can be used in a particularly suitable manner, so that the liquid transport can even be accelerated and/or slowed down in certain areas, depending on the application.

The invention is explained in the following with the aid of figures. The drawings serve for understanding the invention. Identical elements are characterized by the same reference signs. They show:

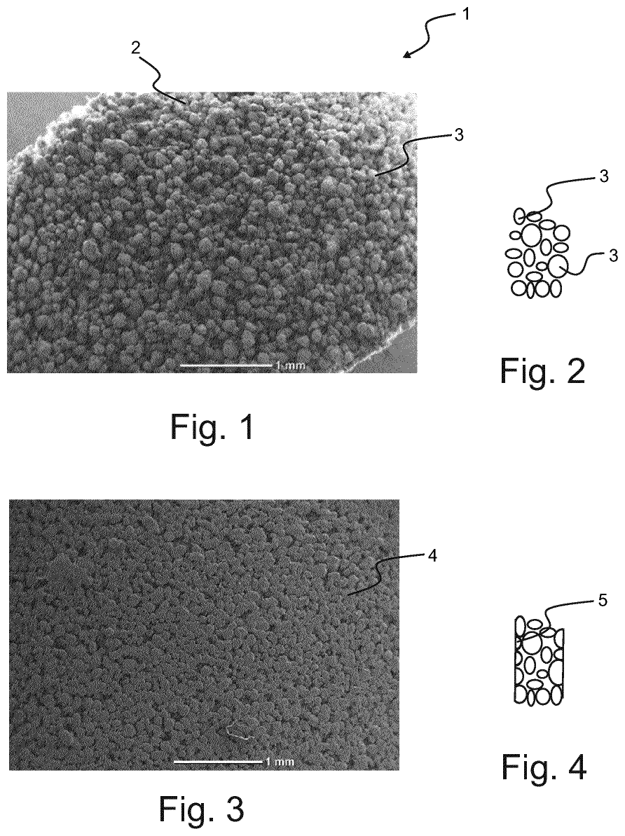

FIG. 1 shows a perspective, enlarged surface view of a filter according to the invention, which is produced by selective laser sintering,

FIG. 2 shows a schematic representation of a cross-section of the filter of FIG. 1 to illustrate a structure of the filter,

FIG. 3 shows a perspective, enlarged surface view of a conventional filter made by sintering, and

FIG. 4 shows a schematic representation of a cross-section of the filter of FIG. 3 to illustrate a structure of the filter.

FIG. 1 shows a filter 1 according to the invention for cleaning fluids. The filter 1 has a main body 2 composed of polyethylene particles 3. The particles 3 are joined together by means of a generative manufacturing process, in particular by selective laser sintering. In this process, the particles 3 are connected to each other in such a way that a predefined macrostructure and microstructure are formed. A macrostructure or a macroporosity is understood to be a structure of the main body that results from the design. This means, therefore, that the macroporosity in particular can be specifically adjusted in order to define, for example, the outer and/or inner geometry, the appearance, the surface properties and/or the microsection of the main body. A microstructure or microporosity is understood to be a structure in the interior of the main body that is created by the process as a result of manufacturing the filter from a mostly powder-like material. This means, therefore, that the microporosity is determined by process parameters such as a particle size.

In a comparison of FIG. 1 with FIG. 3, a difference between a filter 1 produced by laser sintering (FIG. 1) and a filter 4 produced by conventional sintering (compare FIG. 3) can be clearly seen. The laser-sintered filter 1 has a rougher surface, since it is applied in layers, in contrast to the compression-molded filter 4, so that a defined structure on the surface is not damaged, for example is not deformed or crushed by the mold. Thus, the macrostructure of the filter 4 produced by conventional sintering cannot be specifically adjusted. The surface structure or surface texture of the filter 1 according to the invention is independent of the mold used to produce the outer geometry.

The surface of the filter 1 has a defined structure. The structure is formed by the particles 3 which are rounded outwards. The surface of the filter 1 is formed in a scatter-like manner. This means that the particles 3 are round and not flat on the surface. The particles 3 are therefore mechanically non-deformed/undeformed. Interstices are formed between the particles 3, which are open towards the outside. This results in a large surface-to-volume ratio. Preferably, the ratio is greater than 10*1/mm.

According to the invention, the main body 2 has regions in which the porosity is specifically set differently. The porosity of the main body 2 is not the same in every region of the main body 2, but varies. This means, therefore, that the main body 2 has a different porosity in first regions than in second regions of the main body 2, which are arranged at a distance from the first regions. In a conventionally manufactured filter, the porosity cannot be influenced, but results rather randomly. In particular at the surface of a conventionally manufactured filter, the porosity is reduced by the manufacturing process.

In particular, the main body 2 may have greater porosity at the surface than at the interior. Due to the higher permeability at the surface, the fluid to be filtered can easily enter the entire main body 2.

The filter 4 of FIGS. 3 and 4 also has particles 5 arranged to form a surface structure. However, the particles 5 at the surface are mechanically deformed by compression molding. As a result, the spaces at the surface between the individual particles 5 are closed. In contrast to the filter 1, the particles 5 at the surface have flat surfaces. Accordingly, the ratio between the surface area and the volume of the particles 5 is also considerably lower than in the filter 1.

1. Filter for cleaning fluids, having a main body made of polyethylene particles which are bonded to each other by means of a generative manufacturing method in such a way that a predefined macrostructure and microstructure is established, wherein the main body has regions in which the porosity is adjusted differently in a targeted manner, wherein
the filter has a greater porosity at its surface than in an interior of the filter and/or has a coarse-grained surface structure.

2. Filter according to claim 1, wherein the main body is designed as a laser-sintered component.

3. Filter according to claim 1, wherein the particles of the main body are distributed in layers, wherein the particles of one layer are fused/sintered to each other by means of a laser and the particles from different layers are fused/sintered to each other by means of a laser.

4. Filter according to claim 1, wherein the polyethylene particles and/or the main body of the filter are/is provided with a metal doping and/or a ceramic doping.

5. Filter according to claim 1, wherein the particles of the main body are round, potato-shaped, angular, polyhedron-shaped, chip-shaped and/or oval.

6. Filter according to claim 1, wherein the surface of the main body is plasma-treated.

7. Filter according to claim 1, wherein the main body has undercuts and/or cavities.

8. Method for manufacturing a filter according to claim 1, wherein the filter is generatively manufactured by selective laser sintering of polyethylene particles.
